(19) United States
(12) Patent Application Publication
(10) Pub. No.: US 2022/0398352 A1
(43) Pub. Date: Dec. 15, 2022

(54) METHOD FOR MANUFACTURING A REAL COMPONENT, ENABLING AT LEAST ONE ACCEPTANCE CRITERION TO BE DISPLAYED AS A FUNCTION OF A TARGET POINT ON THE COMPONENT

(71) Applicant: Airbus Operations SAS, Toulouse (FR)

(72) Inventors: Dominique ROGER, BLAGNAC (FR); Franck CHEREAU, TOULOUSE (FR)

(21) Appl. No.: 17/835,186

(22) Filed: Jun. 8, 2022

(30) Foreign Application Priority Data
Jun. 14, 2021 (FR) 2106218

(51) Int. Cl. G06F 30/12; G06F 30/15; G06T 19/20; G06T 19/00

(52) U.S. Cl. CPC G06F 30/12; G06F 30/15; G06T 19/20; G06T 19/006; G06F 2111/18

(57) ABSTRACT

A method for manufacturing a real component, enabling at least one acceptance criterion to be displayed by targeting a point on the real component with a pointer of an augmented reality device. The method includes the steps of determining a transfer matrix for converting coordinates of a real point located in a second reference frame into coordinates of a virtual point located in a first reference frame and corresponding to the real point, determining the coordinates in the first reference frame of a virtual point associated with the pointer, using the transfer matrix, determining whether the virtual point associated with the pointer belongs to a criterion area of the virtual component, and, if so, displaying at least one acceptance criterion of the criterion area to which the virtual point associated with the pointer belongs, and addressing the non-conformance according to the acceptance criterion, to make the real component acceptable.

### CROSS-REFERENCES TO RELATED APPLICATIONS

This application claims the benefit of the French patent application No. 2106218 filed on Jun. 14, 2021, the entire disclosures of which are incorporated herein by way of reference.

### FIELD OF THE INVENTION

The present application relates to a method for manufacturing a real component, enabling at least one acceptability criterion to be displayed as a function of a target point on the component.

### BACKGROUND OF THE INVENTION

In the field of aeronautics, during the design of a component, acceptance criteria may be established for certain areas for the purpose of addressing any non-conformances present in these areas on completion of the manufacturing procedure, in order to make the component acceptable.

Because of the number of areas having acceptance criteria and the number of components in an aircraft, the acceptance criteria constitute a large volume of data.

According to one procedure, in a quality inspection operation performed on a component an operator has to analyze each detected non-conformance in order to determine how it is to be addressed. For this purpose, he has to detect the non-conformance, determine the area in which it is located, and retrieve, from a large body of data, the acceptance criteria associated with this area.

The step of determining the area in which the non-conformance is located may be problematic in the case of a component that is large, complex and/or lacking a visual frame of reference.

The step of searching for the acceptance criteria associated with the area in which the detected non-conformance is located is usually time-consuming, owing to the volume of data that must be searched.

The document U.S. Ser. No. 10/740,987 describes an augmented reality device for displaying information relating to non-conformances present on an object, such as an aircraft fuselage, which can be viewed by a camera.

In a preliminary step, the non-conformances have been identified and listed in a database.

The operator wishing to display the non-conformances visible in an area to be inspected, together with their information, uses a portable computer equipped with a camera, a system for scanning the object, and a display screen. Using his portable computer, the operator films the object or part of the object. The filmed scene is displayed on the screen. At the same time, the scanning system constructs a point cloud from which an application builds a virtual model of the object displayed in a virtual reference frame and determines the position and orientation of the camera.

On the basis of this information, an application positions, in the virtual reference frame, the points corresponding to the non-conformances present in the real object, determines the set of points visible on the displayed image on the basis of the position and orientation of the camera, and then superimposes on the screen a display of the information relating to the non-conformances for the set of visible points in the scene.

This device is relatively complicated and requires the reconstruction of a virtual model from a point cloud. It is relatively imprecise and does not enable the data relating to a single non-conformance to be isolated, notably if the displayed scene comprises a large number of non-conformances.

The present invention is intended to overcome all or some of the drawbacks of the prior art.

### SUMMARY OF THE INVENTION

For this purpose, the invention proposes a method of manufacturing a real component having at least one non-conformance, said real component corresponding to a virtual component defined in a first reference frame and having at least one criterion area, each criterion area being defined in the first reference frame and having at least one acceptance criterion.

According to the invention, the method comprises:

a step of displaying the real component with an augmented reality device, configured for displaying a pointer superimposed on the real component and for determining coordinates of the pointer in a second reference frame,

a step of determining a transfer matrix for converting coordinates of a real point located in the second reference frame into coordinates of a virtual point located in the first reference frame and corresponding to the real point,

a step of positioning the pointer so that it targets the non-conformance,

a step of determining coordinates in the first reference frame of a virtual point associated with the pointer on the basis of the transfer matrix and coordinates in the second reference frame of the pointer,

a step of determining whether the virtual point associated with the pointer belongs to a criterion area,

and, if this is the case, a step of displaying at least one acceptance criterion of the criterion area to which the virtual point associated with the pointer belongs,

a step of addressing the non-conformance according to the acceptance criterion, in order to make the real component acceptable.

The method of the invention makes it possible to automate the selection and display of the acceptance criteria of a criterion area in which a non-conformance is located.

According to another feature, each criterion area comprises at least one set of virtual points to which each acceptance criterion of the criterion area is applied. Additionally, during the step of determining whether the virtual point associated with the pointer belongs to a criterion area, the coordinates in the first reference frame of the virtual point associated with the pointer are compared with the coordinates of the virtual points of each set of virtual points of each criterion area in order to determine whether this virtual point belongs to one of these sets of virtual points and to a criterion area.

According to another feature, the step of determining the transfer matrix consists in determining coordinates of at least three virtual calibration points in the first reference frame, for each virtual calibration point in the first reference frame corresponding to a real calibration point in the second reference frame; determining coordinates in the second reference frame for each real calibration point; and then determining the transfer matrix on the basis of the coordinates of each virtual calibration point in the first reference frame and those of each real calibration point in the second reference frame.

According to another feature, the coordinates of each real calibration point in the second reference frame are determined by targeting each of the real calibration points in turn with the pointer.

According to another feature, a representation of the virtual component is displayed in superimposition on the real component.

According to another feature, the acceptance criterion or criteria are displayed according to a static position of the pointer.

According to another feature, the acceptance criterion or criteria displayed vary according to the real time position of the movable pointer in the second reference frame.

According to another feature, at least one image of the real component is acquired, this image showing the pointer pointing to a non-conformance together with at least one acceptance criterion of the criterion area in which the virtual point associated with the pointer is located.

### BRIEF DESCRIPTION OF THE DRAWINGS

Other features and advantages will be apparent from the following description of the invention, this description being provided solely by way of example, with reference to the attached drawings, of which:

FIG. 1 is a perspective view of a virtual model of an aircraft,

FIG. 2 is a schematic representation of a virtual component comprising at least one criterion area, illustrating an embodiment of the invention,

FIG. 3 is a perspective view of an operator equipped with an augmented reality device displaying a real component on which a non-conformance is present, illustrating an embodiment of the invention,

FIG. 4 is a representation of the field of view of an operator seen through an augmented reality device during a calibration step, illustrating an embodiment of the invention, and

FIG. 5 is a representation of the field of view of an operator viewed through an augmented reality device in a step of displaying acceptance criteria associated with the area in which a non-conformance is present, illustrating an embodiment of the invention.

### DETAILED DESCRIPTION OF THE PREFERRED EMBODIMENTS

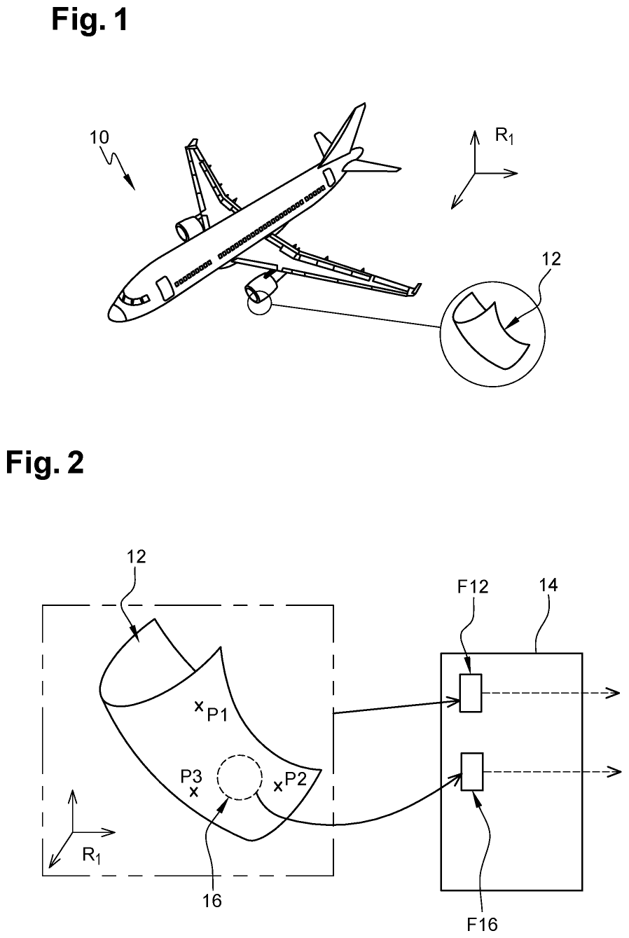

In FIG. 1, the number 10 indicates a virtual model of an aircraft in a first reference frame R1. This virtual model comprises a large number of virtual components 12 or assemblies of components.

For the purposes of the present application, a “component” is taken to mean a single component or a number of components, such as an assembly of components.

At least one virtual component 12 is defined in at least one digital component file F12. The virtual model 10 of the aircraft comprises a large number of digital component files F12. The various digital component files F12 may be stored in a storage device 14. These various digital component files F12 may be exported and/or converted into any file compatible with an augmented reality device.

As shown in FIG. 2, a representation of the virtual component 12 may be displayed on the basis of the digital component file F12 in the first reference frame R1, using a display software adapted to the file. Each virtual point of the virtual component 12 has coordinates expressed in the first reference frame R1.

By way of example, the virtual component 12 corresponds to part of an air intake of an aircraft nacelle. Evidently, the invention is not limited to this component.

The virtual model 10 of the aircraft comprises at least one criterion area 16 having at least one acceptance criterion. Usually, the virtual model 10 comprises a number of criterion areas 16, each having at least one acceptance criterion.

In one configuration, a virtual component 12 has one or more criterion areas 16.

Each criterion area 16 is defined in an area file F16, comprising each acceptance criterion of the criterion area 16 concerned, together with at least one area coordinate for delimiting and positioning the criterion area 16 in the first reference frame R1. Thus, each criterion area 16 comprises at least one set of virtual points to which each acceptance criterion of the criterion area 16 is applied.

The various area files F16 may be stored in a storage device, which may be the same as that used for the digital component files F12. These various area files F16 may be exported and/or converted into any file compatible with an augmented reality device.

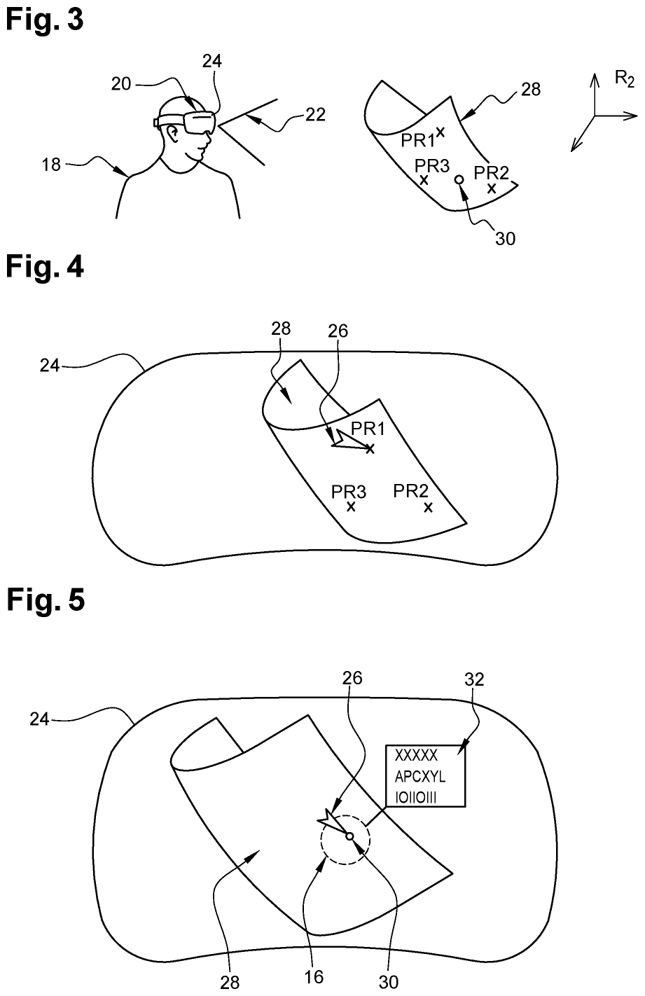

In order to implement a method of displaying at least one acceptance criterion, as shown in FIG. 3, an operator 18 is provided with an augmented reality device 20, such as spectacles, configured for displaying at least one piece of information in the field of view 22 of the operator 18.

This augmented reality device 20 is configured for displaying at least one pointer 26 on a screen 24 in the field of view 22 of the operator 18.

The augmented reality device 20 comprises at least one piece of software configured for displaying the pointer 26 and for determining the coordinates of the pointer 26 in a second reference frame R2 associated with a real environment.

As shown in FIGS. 3 and 4, a real component 28 corresponding to the virtual component 12 is displayed by the operator 18 using the augmented reality device, the pointer 26 being displayed on the screen 24 in superimposition on the real component 28. This real component 28 may comprise at least one non-conformance 30 at the end of its manufacturing procedure.

The real component 28 is identical to the virtual component 12. Each real point of the real component 28 corresponds to a virtual point of the virtual component 12.

The digital component file F12 of the virtual component 12 corresponding to the real component 28, together with the area file F16 of each criterion area 16 present on the virtual component 12, are converted or exported into files that can be used by the software implemented in the augmented reality device 20.

According to one procedure, a method of displaying at least one acceptance criterion comprises a phase of determining a transfer matrix for converting coordinates of a real point located in the second reference frame R2 into coordinates of a virtual point located in the first reference frame R1 and corresponding to the real point. Additionally, an inverse transfer matrix is determined in order to convert coordinates of a virtual point located in the first reference frame R1 into coordinates of a real point located in the second reference frame R2 and corresponding to the virtual point.

This phase of determining the transfer matrix comprises a step of selecting at least three virtual calibration points P1, P2, P3 located in the first reference frame R1 on the virtual model 10 of the aircraft, and a step of determining the coordinates of each virtual calibration point P1, P2, P3 in the first reference frame R1. As shown in FIG. 2, the virtual calibration points P1, P2, P3 are positioned on the virtual component 12.

For each virtual calibration point P1, P2, P2, the real component 28 has a real calibration point PR1, PR2, PR3 which corresponds to said virtual calibration point P1, P2, P3. The virtual calibration points P1, P2, P2 are noteworthy points, chosen so that the corresponding real calibration points PR1, PR2, PR3 are easily identifiable on the real component 28.

The phase of determining the transfer matrix also comprises a step of determining coordinates in the second reference frame R2 of each real calibration point PR1, PR2, PR3 of the real component 28. According to one procedure, the augmented reality device 20 is used for implementing this step, the pointer 26 targeting each of the real calibration points PR1, PR2, PR3 in turn.

Given the coordinates of each virtual calibration point P1, P2, P3 in the first reference frame R1, and those of each real calibration point PR1, PR2, PR3 in the second reference frame R2, the transfer matrix may be determined.

This phase of determining the transfer matrix may be executed once only for each real component 28. It does not have to be repeated between two non-conformances 30.

When the phase of determining the transfer matrix has been completed, the method of displaying at least one acceptance criterion comprises the following steps, for each detected non-conformance 30:

positioning the pointer 26 of the augmented reality device 20 so that it targets the non-conformance 30,

determining the coordinates in the second reference frame R2 of the pointer 26 pointing to the detected non-conformance 30,

determining the coordinates in the first reference frame R1 of a virtual point associated with the pointer 26 on the basis of the transfer matrix and the coordinates in the second reference frame R2 of the pointer 26 pointing to the non-conformance 30,

determining whether this virtual point belongs to a criterion area 16,

if this is the case, displaying at least one acceptance criterion 32 of the criterion area 16 to which the virtual point associated with the pointer 26 belongs, as shown in FIG. 5.

For the purpose of determining whether a virtual point belongs to a criterion area 16, the coordinates in the first reference frame R1 of the virtual point associated with the pointer 26 are compared with the coordinates of the virtual points of each set of virtual points of each criterion area 16, in order to determine whether this virtual point belongs to one of these sets of virtual points and, ultimately, to a criterion area.

According to a first procedure, these various steps are executed in a static manner, the acceptance criteria being displayed according to a static position of the pointer 26 targeting the detected non-conformance 30.

According to a second procedure, these various steps are executed dynamically, the displayed acceptance criteria varying according to the real time position of the movable pointer 26 in the second reference frame R2.

The acceptance criteria 32 may be displayed according to the position of the pointer 26, without any non-conformance necessarily being detected. Thus, the pointer 26 may target any other element, such as a fastening or an aperture, for example.

Thus, the coordinates in the first reference frame R1 of the virtual point associated with the pointer 26 are determined in real time on the basis of the transfer matrix and the coordinates in the second reference frame R2 of the pointer 26. Then, if the virtual point associated with the pointer 26 belongs to a criterion area 16, the acceptance criteria 32 of this criterion area 16 are displayed.

To facilitate the detection of the non-conformances, the representation of the virtual component 12 is displayed on the screen 24 of the augmented reality device 20, being superimposed on the corresponding real component 28 by making the real calibration points PR1, PR2, PR3 and the virtual calibration points P1, P2, P3 correspond, and/or by using the transfer matrix or the inverse transfer matrix. The coordinates of the pointer 26 are also displayed on the screen 24.

To facilitate the addressing of a non-conformance 30, at least one image of the real component 28 is acquired, this image showing the pointer 26 pointing to the detected non-conformance 30 together with the acceptance criteria 32 of the criterion area 16 in which the virtual point associated with the pointer 26 is located.

The augmented reality device 20 may be configured for acquiring such an image.

The method of the invention makes it possible to automate the selection and display of the acceptance criteria of a criterion area in which a non-conformance is located. It also makes it possible to simplify the determination of the position of a non-conformance and the search for the acceptance criteria associated with the non-conformance.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of manufacturing a real component having at least one non-conformance, said real component corresponding to a virtual component defined in a first reference frame and having at least one criterion area, each criterion area being defined in the first reference frame and having at least one acceptance criterion, characterized in that the method comprises:
displaying the real component with an augmented reality device, configured to display a pointer superimposed on the real component and for determining coordinates of the pointer in a second reference frame,
determining a transfer matrix for converting coordinates of a real point located in the second reference frame into coordinates of a virtual point located in the first reference frame and corresponding to the real point,
positioning the pointer to target the non-conformance,
determining coordinates in the first reference frame of a virtual point associated with the pointer based on the transfer matrix and the coordinates in the second reference frame of the pointer,
determining whether the virtual point associated with the pointer belongs to a criterion area,
if this is so, displaying at least one acceptance criterion of the criterion area to which the virtual point associated with the pointer belongs,
addressing the non-conformance according to the acceptance criterion, in order to make the real component acceptable.

2. The manufacturing method as claimed in claim 1,
wherein each criterion area comprises at least one set of virtual points to which each acceptance criterion of the criterion area applies, and
wherein, during the step of determining whether the virtual point associated with the pointer belongs to a criterion area, the coordinates in the first reference frame of the virtual point associated with the pointer are compared with the coordinates of the virtual points of each set of virtual points of each criterion area in order to determine whether this virtual point belongs to one of the sets of virtual points and to a criterion area.

3. The manufacturing method as claimed in claim 1, wherein the step of determining the transfer matrix comprises
determining coordinates of at least three virtual calibration points in the first reference frame, for each virtual calibration point in the first reference frame corresponding to a real calibration point in the second reference frame;
determining coordinates in the second reference frame for each real calibration point; and then
determining the transfer matrix based on the coordinates of each virtual calibration point in the first reference frame and those of each real calibration point in the second reference frame.

4. The manufacturing method as claimed in claim 3, wherein the coordinates of each real calibration point in the second reference frame are determined by targeting each of the real calibration points in turn with the pointer.

5. The manufacturing method as claimed in claim 4, wherein a representation of the virtual component is displayed in superimposition on the real component.

6. The manufacturing method as claimed claim 1, wherein the acceptance criterion or criteria are displayed according to a static position of the pointer.

7. The manufacturing method as claimed in claim 1, wherein the acceptance criterion or criteria displayed vary according to a real time position of the movable pointer in the second reference frame.

8. The manufacturing method as claimed in claim 1, wherein at least one image of the real component is acquired, this image showing the pointer pointing to a non-conformance together with at least one acceptance criterion of the criterion area in which the virtual point associated with the pointer is located.
